(19) United States
(12) Patent Application Publication
(10) Pub. No.: US 2026/0115744 A1
(43) Pub. Date: Apr. 30, 2026

(54) Amplitude-Adjustable Electric Spray Gun Structure

(71) Applicants: Junpeng Wei, Taizhou (CN); Zhenxing Ying, Taizhou (CN); FaZheng Yang, Taizhou (CN); Xiaopeng Li, Taizhou (CN)

(72) Inventors: Junpeng Wei, Taizhou (CN); Zhenxing Ying, Taizhou (CN); FaZheng Yang, Taizhou (CN); Xiaopeng Li, Taizhou (CN)

(73) Assignee: Zhejiang Rongpeng Air Tools Co. Ltd., Taizhou (CN)

(21) Appl. No.: 18/925,029

(22) Filed: Oct. 24, 2024

(51) Int. Cl. B05B 7/12; B05B 7/04

(52) U.S. Cl. CPC B05B 7/12; B05B 7/0416

(57) ABSTRACT

An amplitude-adjustable electric spray gun structure, comprising a gun body, motor, paint container, trigger, nozzle assembly, and paint needle. The gun body contains three channels and is equipped with an amplitude adjustment assembly. The nozzle assembly includes both a main and secondary atomization channel. The first channel connects to the motor's air outlet and the main atomization channel. The amplitude adjustment assembly controls the connection and gap between the first and third channels, enabling the airflow to the secondary atomization channel to be adjusted for optimal spray control.

### FIELD OF THE INVENTION

The present invention relates to the technical field of spray guns, specifically to an amplitude-adjustable electric spray gun structure.

### BACKGROUND OF THE INVENTION

A spray gun is a tool for spraying paint. The spray gun uses compressed air, which is rapidly released as power to eject paint from the nozzle. The design between the nozzle and the needle rod is particularly crucial for the spraying effect.

Electric spray guns need to atomize paint into different shapes depending on various spraying needs. Existing electric spray guns atomize paint into circular and certain elliptical shapes. During the transition from circular to elliptical, the atomization length cannot be adjusted arbitrarily based on actual spraying requirements. Furthermore, existing electric spray guns with amplitude-adjustable functionality are complex in structure and have high manufacturing costs. Therefore, there is a need to improve the amplitude-adjustment structure in current electric spray guns.

### SUMMARY OF THE INVENTION

The objective of this utility model is to solve the problems presented in the background technology by providing an amplitude-adjustable electric spray gun structure.

To achieve the above objective, the technical solution of this utility model is as follows:

An amplitude-adjustable electric spray gun structure includes a gun body, motor, paint container, trigger, nozzle assembly, and paint needle. The gun body is provided with three channels, and an amplitude adjustment assembly is installed on the gun body. The nozzle assembly contains a main atomization channel and a secondary atomization channel. Channel one connects with the motor's air outlet and the main atomization channel, while channel two connects to the paint passage in the gun body. The amplitude adjustment assembly controls the connection and gap size between channels one and three, allowing for the control of the air opening and airflow adjustment of the secondary atomization channel.

In the aforementioned amplitude-adjustable electric spray gun structure, the amplitude adjustment assembly includes an amplitude adjustment knob, amplitude adjustment screw, and amplitude adjustment screw seat. The amplitude adjustment screw seat is fixedly connected to the gun body, and the amplitude adjustment screw is threadedly connected to the amplitude adjustment screw seat, while the amplitude adjustment knob is connected to the amplitude adjustment screw seat. The gun body is provided with a vent hole that connects channels one and three, and the rotation of the amplitude adjustment screw controls the opening and the size of the vent hole, thereby controlling the connection between channels one and three and the secondary atomization channel. Through the rotation of the amplitude adjustment screw, the air opening and airflow adjustment of the secondary atomization channel in the nozzle assembly are controlled.

In the aforementioned amplitude-adjustable electric spray gun structure, the nozzle assembly includes an atomization cap, fixing cap, nozzle body, and needle seat. The fixing cap secures the nozzle assembly to the gun body, and a secondary atomization channel is formed between the nozzle body and the atomization cap, while the main atomization channel is formed between the atomization cap and the needle seat. Channel three connects with the secondary atomization channel and the air holes on the upper side of the atomization cap.

In the aforementioned amplitude-adjustable electric spray gun structure, the end of the amplitude adjustment screw corresponding to the vent hole is provided with an annular tapered surface.

In the aforementioned amplitude-adjustable electric spray gun structure, channels one and three are arranged along the same central axis.

In the aforementioned amplitude-adjustable electric spray gun structure, the gun body is provided with a paint container vent hole, and channel one is connected to the interior of the paint container through the vent hole.

In the aforementioned amplitude-adjustable electric spray gun structure, a duckbill valve is provided at the end of the paint container vent hole that connects with the paint container.

In the aforementioned amplitude-adjustable electric spray gun structure, channel two is connected to the paint container via a paint pipe.

In the aforementioned amplitude-adjustable electric spray gun structure, a positioning tab is provided on the amplitude adjustment screw that can abut against the amplitude adjustment screw seat.

By adopting the above technical solution, this utility model achieves the following beneficial effects:

The present invention achieves connection and gap size adjustment between channels one and three through the rotation of the amplitude adjustment knob, which drives the movement of the amplitude adjustment screw. This controls the air opening and airflow adjustment of the secondary atomization channel, allowing for switching between circular and elliptical spray patterns. Furthermore, during the rotation of the amplitude adjustment screw, the gap size between channels one and three is adjusted, enabling the atomized elliptical spray pattern to have an adjustable length based on actual requirements during the switch from circular to elliptical. This utility model features a simple structure, easy operation, and convenience in use.

### BRIEF DESCRIPTION OF THE DRAWINGS

FIG. 1 is a perspective view of the present invention;

FIGS. 2 and 4 are perspective sectional views of the present invention from two different directions;

FIG. 3 is an enlarged view of part A in FIG. 2;

FIG. 5 is an exploded view of the present invention.

### DETAILED DESCRIPTION OF THE EMBODIMENT

The present invention will be further explained in conjunction with the drawings.

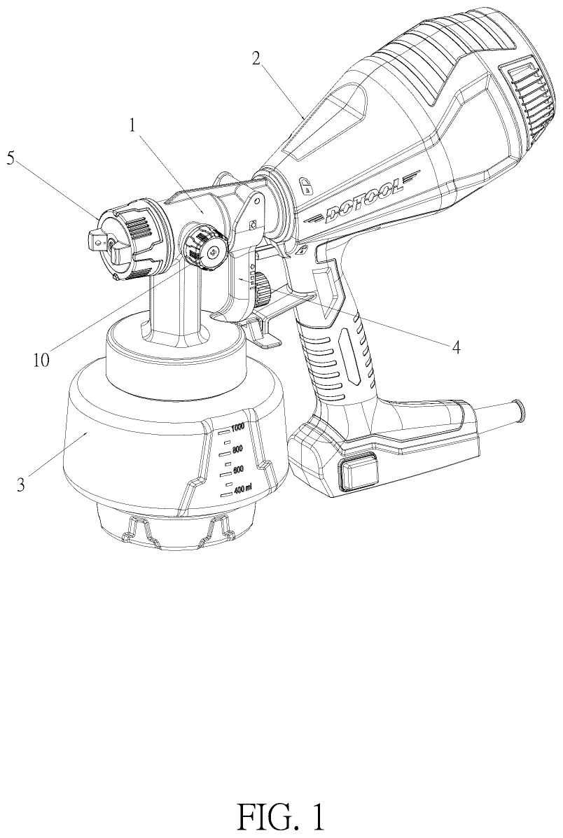

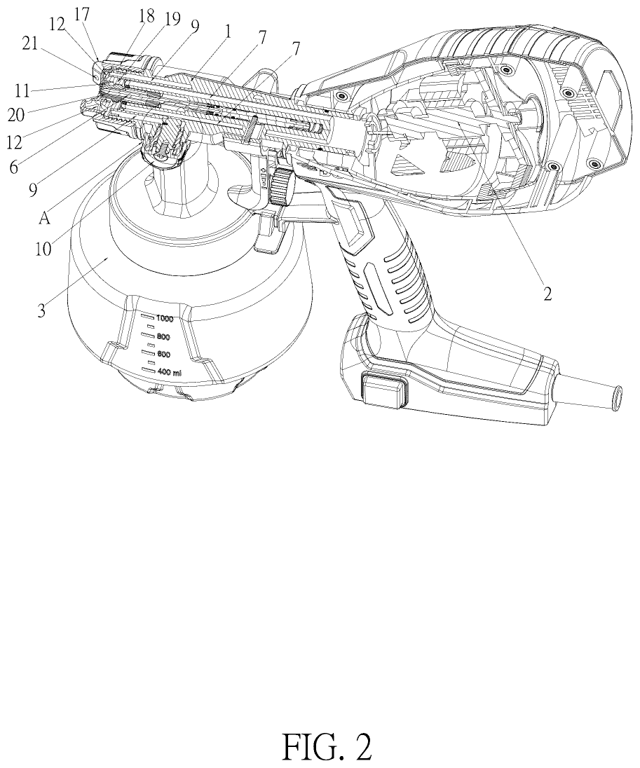

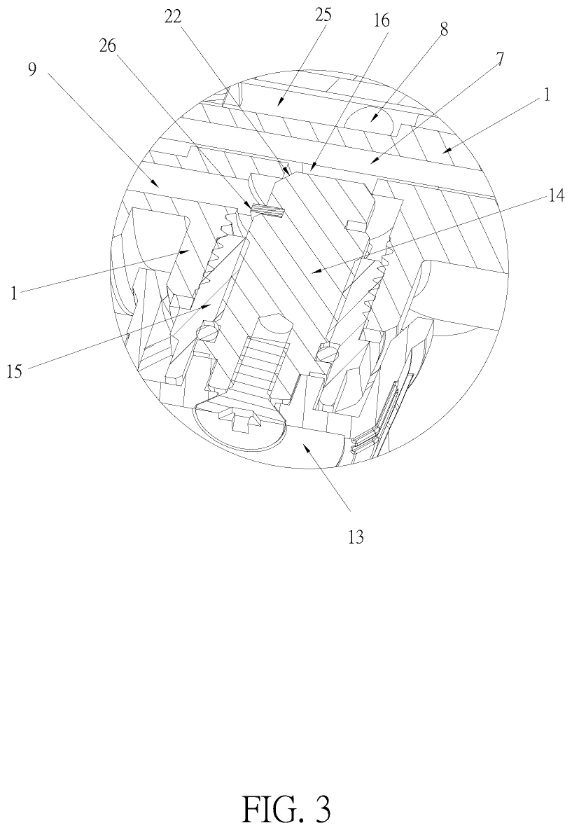

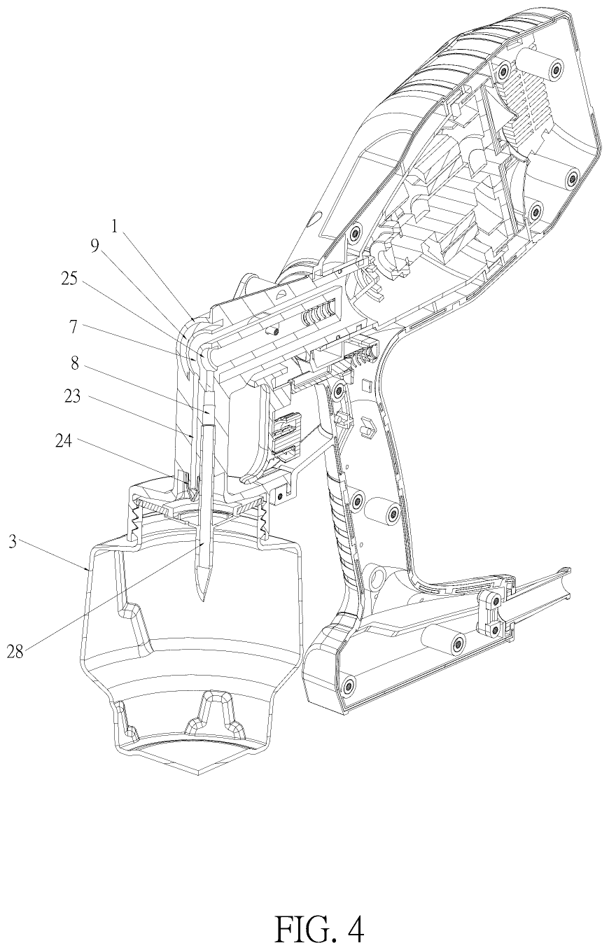

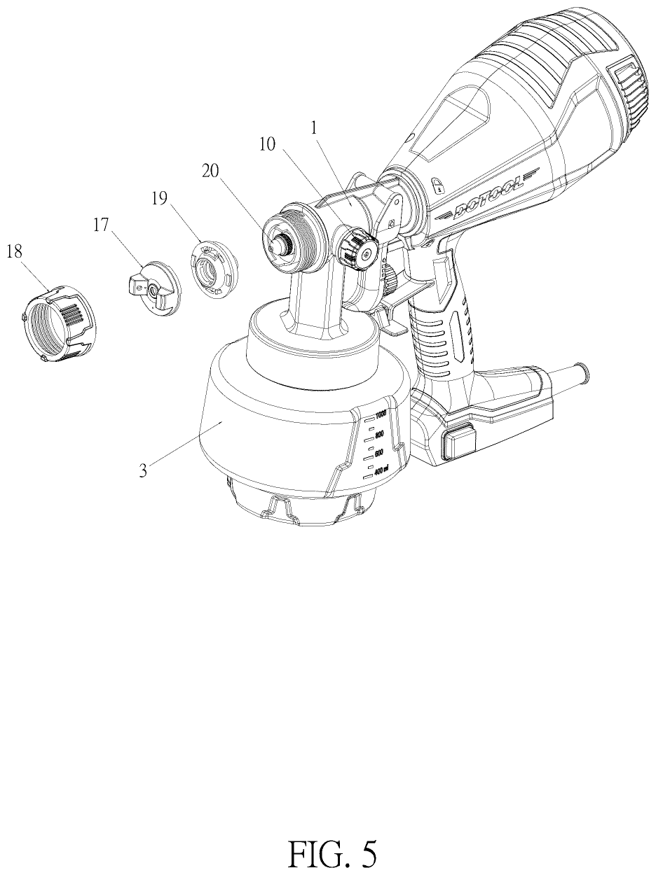

Please refer to FIGS. 1 to 5. The present invention provides an amplitude-adjustable electric spray gun structure, which includes a gun body 1, motor 2, paint container 3, trigger 4, nozzle assembly 5, and paint needle 6. The gun body 1 is equipped with three channels: channel one 7, channel two 8, and channel three 9. The gun body 1 is also equipped with an amplitude adjustment assembly 10.

The nozzle assembly 5 includes an atomization cap 17, a fixing cap 18, a nozzle body 19, and a needle seat 20. The fixing cap 18 fixes the nozzle assembly 5 to the gun body 1. A secondary atomization channel 12 is formed between the nozzle body 19 and the atomization cap 17, while a main atomization channel 11 is formed between the atomization cap 17 and the needle seat 20. Channel three 9 connects to the secondary atomization channel 12 and the air holes 21 on the upper side of the atomization cap 17.

The amplitude adjustment assembly 10 includes an amplitude adjustment knob 13, an amplitude adjustment screw 14, and an amplitude adjustment screw seat 15. The amplitude adjustment screw seat 15 is fixedly connected to the gun body 1. The amplitude adjustment screw 14 is threadedly connected to the amplitude adjustment screw seat 15, and the amplitude adjustment knob 13 is connected to the amplitude adjustment screw seat 15. A vent hole 16 is provided in the gun body 1 to connect channel one 7 and channel three 9.

Channel one 7 connects the motor's air outlet and the main atomization channel 11, while channel two 8 connects with the paint passage 25 inside the gun body. The amplitude adjustment assembly 10 controls the connection between channel one 7 and channel three 9 and adjusts the gap size. Specifically, the rotation of the amplitude adjustment screw 14 controls the opening and the gap size of the vent hole 16, thereby controlling the connection between channel one 7 and channel three 9, as well as the secondary atomization channel 12. Through the rotation of the amplitude adjustment screw 14, the air opening and airflow of the secondary atomization channel 12 can be controlled.

Furthermore, to facilitate the adjustment of the air gap, the end of the amplitude adjustment screw 14 corresponding to the vent hole 16 is provided with an annular tapered surface 22.

Additionally, channel three 9 and channel one 7 are arranged on the same central axis.

Specifically, the gun body 1 is provided with a paint container vent hole 23, and channel one 7 is connected to the interior of the paint container 3 through the paint container vent hole 23.

Moreover, a duckbill valve 24 is provided at the end of the paint container vent hole 23 that connects to the paint container 3.

Channel two 8 is connected to the paint container 3 via a paint pipe 28.

Furthermore, a positioning tab 26 is provided on the amplitude adjustment screw 14, which can abut against the amplitude adjustment screw seat 15 to prevent the amplitude adjustment screw 14 from rotating and falling off.

The working principle of the present invention is further explained as follows:

After the power is connected, pulling the trigger 4 activates the switch, causing the motor 2 to start working, and the paint needle 6 moves back, opening the paint passage 25 at the needle seat. As the motor runs, air flows through channel one 7 into the gun body. When the amplitude adjustment knob 13 is tightened and closed, air passes through channel one 7 in the gun body and flows into the paint container 3 via the paint container vent hole 23 and the duckbill valve 24. Due to the pressure, the paint is forced through the paint pipe into the paint passage in the gun body and reaches the needle seat 20. Simultaneously, air from channel one 7 flows through the main atomization channel 11, creating a siphoning and atomizing effect on the paint at the needle seat, evenly atomizing the paint and spraying it onto the target surface in a circular pattern.

When the amplitude adjustment knob 13 is rotated to open, the amplitude adjustment screw 14 moves, creating a gap at the contact point between the amplitude adjustment screw and the vent hole 16. Air is diverted from channel one 7 to channel three 9, and the air flows through channel three to the secondary atomization channel 12. Both the main atomization channel 11 and the secondary atomization channel 12 create a siphoning and atomizing effect on the paint, and the air from the upper-side air holes 21 of the atomization cap 17 presses the paint, forming an elliptical atomized spray.

Rotating the amplitude adjustment knob to different angles adjusts the gap between the amplitude adjustment screw and the vent hole 16. The larger the rotation, the larger the gap, and the longer the atomized spray becomes. Conversely, the spray length shortens as the gap decreases, and when the gap is zero, the spray pattern returns to circular.

The above provides a detailed description of the amplitude-adjustable electric spray gun structure as presented in this utility model. Specific examples have been applied to illustrate the principles and implementation of this utility model. The explanations of the embodiments are intended to help understand the technical solutions disclosed in this utility model. Additionally, for those skilled in the field, variations in specific implementation methods and application scopes may arise based on the concepts of this utility model. Therefore, the content of this specification should not be construed as limiting the present invention.

We claim:

1. An amplitude-adjustable electric spray gun structure, comprising:
a gun body (1), motor (2), paint container (3), trigger (4), nozzle assembly (5), and paint needle (6); wherein
the gun body (1) is provided with a first channel (7), a second channel (8), and a third channel (9); the gun body (1) is also equipped with an amplitude adjustment assembly (10);
the nozzle assembly (5) is provided with a main atomization channel (11) and a secondary atomization channel (12), the second channel (8) is connected to the paint passage (25) inside the gun body (1); the first channel (7) is connected to the air outlet of the motor (2) and the main atomization channel (11);
the amplitude adjustment assembly (10) controls the connection between the first channel (7) and the third channel (9), as well as the adjustment of the connection gap size, thereby realizing the control of the air opening and airflow adjustment of the secondary atomization channel (12).

2. The amplitude-adjustable electric spray gun structure according to claim 1, wherein the amplitude adjustment assembly (10) comprises an amplitude adjustment knob (13), an amplitude adjustment screw (14), and an amplitude adjustment screw seat (15); the amplitude adjustment screw seat (15) is fixedly connected to the gun body (1), and the amplitude adjustment screw (14) is threadedly connected to the amplitude adjustment screw seat (15) the amplitude adjustment knob (13) is connected to the amplitude adjustment screw seat (15);
the gun body (1) is provided with a vent hole (16) that connects the first channel (7) and the third channel (9), and the rotation of the amplitude adjustment screw (14) controls the opening and the gap size of the vent hole (16), thereby controlling the connection between the first channel (7), the third channel (9), and the secondary atomization channel (12); through the rotation of the amplitude adjustment screw (14), the air opening and airflow adjustment of the secondary atomization channel (12) in the nozzle assembly (5) are controlled.

3. The amplitude-adjustable electric spray gun structure according to claim 1, wherein the nozzle assembly (5) comprises an atomization cap (17), fixing cap (18), nozzle body (19), and needle seat (20); the fixing cap (18) secures the nozzle assembly (5) to the gun body (1); a secondary atomization channel (12) is formed between the nozzle body (19) and the atomization cap (17), while a main atomization channel (11) is formed between the atomization cap (17) and the needle seat (20); the third channel (9) is connected to the secondary atomization channel (12) and the air holes (21) on the upper side of the atomization cap (17).

4. The amplitude-adjustable electric spray gun structure according to claim 2, wherein the end of the amplitude adjustment screw (14) corresponding to the vent hole (16) is provided with an annular tapered surface (22).

5. The amplitude-adjustable electric spray gun structure according to claim 2, wherein the third channel (9) and the first channel (7) are arranged along the same central axis.

6. The amplitude-adjustable electric spray gun structure according to claim 1, wherein the gun body (1) is provided with a paint container vent hole (23), and the first channel (7) is connected to the interior of the paint container (3) through the paint container vent hole (23).

7. The amplitude-adjustable electric spray gun structure according to claim 6, wherein the end of the paint container vent hole (23) that connects with the paint container (3) is provided with a duckbill valve (24).

8. The amplitude-adjustable electric spray gun structure according to claim 1, wherein the second channel (8) is connected to the paint container (3) through a paint pipe (28).

9. The amplitude-adjustable electric spray gun structure according to claim 2, wherein the amplitude adjustment screw (14) is provided with a positioning tab (26) that can abut against the amplitude adjustment screw seat (15).
